(19) United States
(12) Patent Application Publication
(10) Pub. No.: US 2007/0026946 A1
(43) Pub. Date: Feb. 1, 2007

(54) Method and apparatus for automatically updating a video game

(76) Inventor: Douglas Jeffery Newborn, Goose Creek, SC (US)

Correspondence Address: LAW OFFICE OF STEVEN B. LEAVITT, L.L.P., P.O. BOX 537, ROWLETT, TX, 75030-0537, US

(21) Appl. No.: 11/193,264

(22) Filed: Jul. 30, 2005

(51) Int. Cl. A63F 13/00

(52) U.S. Cl. 463/42; 463/1

(57) ABSTRACT

This invention relates to video games, specifically sports related video games, and the ability to interchange data sets and statistics related to player attributes and stats. The present invention allows for the interchange of data via non-volatile, and flash memory, online updating through global networks and various other memory updating implementation.

### BACKGROUND OF THE INVENTION

1. Technical Field

This invention relates to the updating of statistical information related to video games, and more particularly to sports related videogames.

2. Description of Related Art

America was introduced to the first home video game system on a Sunday night television broadcast hosted by Frank Sinatra. Released by Magnavox and named “ODYSSEY” this system was little more than a few logic switches and was not considered a microcomputer by the industry. This was not, however, the first time that Americans had seen a videogame. The game “PONG,” created by Nolan Bushnell and Al Alcom (founder and first employee of ATARI, respectively), had been around for nearly a year in game arcades prior to the release of ODYSSEY. Thus videogames were not new. However, a system to play video games in the privacy of your own home had never been seen before.

Nolan Bushnell was not to be outdone, and with simplicity as his motto, he reproduced his popular arcade game PONG for home use. ATARI's PONG, the home version, consisted of one simple unit having integral paddles, a built in speaker and was preprogrammed with one game: PONG.

Today's videogames use 64-bit graphics and specialized hardware. Game designers are inhibited only by their creativity and available technology. The ultimate goal of most game designers is to make the video game appear as realistic as possible. This is especially true in sports based videogames.

However, often events happen after the games has been coded and manufactured that take away the realistic aspect of the game. For example, nobody saw the football player Ricky Williams retiring one week before the start of pre-season in the year 2004. Because of that unforeseen event, 2004 video football games had Ricky Williams as the running back for the Miami Dolphins football team even though he was no longer playing.

Consequently, sport gamers (individuals who are typically avid players of sports video games) were unable to play games that mirrored the reality of this change as associated with real-life sports. What is needed is an apparatus and method to mimic the real world dynamics of a particular sport such as injuries, trades, or unexpected hall-of-fame, career defining seasons by players. The system and method should provide for a nucleus of game statistical data and a fixed statistical database, that can be utilized in conjunction with interchangeable statistical databases, so as to permit constant, easily obtained updates for players to reflect changes in real life play.

### SUMMARY OF INVENTION

In accordance with one aspect of the present invention, a statistical updating mechanism is provided wherein a core game application logic provides video game logic and a statistical database. The video game logic system processes the data in the statistical database and controls the game play. The statistical database comprising a fixed portion and a variable portion which together form the complete statistical data set associated with the video game. By statistical data set it is meant a collection of data records for computer processing.

The fixed portion contains most of the data in the statistical database including the following: games rules, environments, identifiable logic, and other aspects of the gaming environment that should remain static throughout the life of the game. The variable portion is variable and contains data relating to the players, coaches, and any other elements of the gaming environment that could change throughout the life of the game. Because a majority of the data in the statistical database is contained within the fixed portion, the data contained in the variable portion can be updated relatively quickly and easily to reflect changes in real life permitting an update of dynamic statistical content relative to the video game, while retaining the core video game rules and identifiable logic.

The variable portion may be updated via flashRAM, ROM, CDROM, DVD, hard disk, provided responsive to user generation, online downloads, or other similar methods.

The update link is preferably loaded onto local RAM memory of the computing system processing and running the video game. The updates may be free or charged on a onetime or subscription type basis.

In the preferred embodiment, the fixed portion establishes the base level of statistics associated with each videogame object and provides the game with base line data about the videogame object held in the statistical database. The fixed portion and variable portion are managed and controlled by a statistical-mapper which controls the exchange of data between the fixed portion and variable portion.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein

FIG. 1 is a side view of a system using the present invention; and

FIG. 2 is a cut-away view of an alternate embodiment of the present invention.

### DETAILED DESCRIPTION OF THE INVENTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

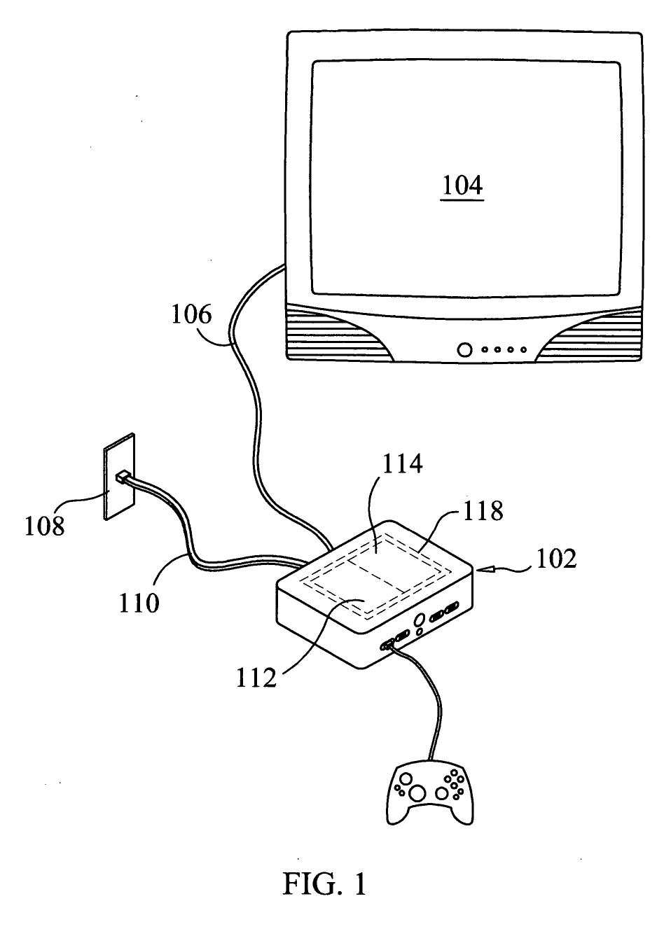

FIG. 1, shows video game system 102 connected to television 104 via display cord 106. Game system 102 may be any video game system, including but not limited to, the SONY PLAYSTATION produced by the Sony Corporation located in Tokyo Japan, NINTENDO GAME CUBE produced by Nintendo of America located in Redmond, Wash., or MICROSOFT XBOX produced by the Microsoft Corporation located in Redmond, Wash. and further includes use of CDs and DVDs in a computer running an operating system such as WINDOWS, LINUX, MACINTOSH, or other computer operating system. Television 104 may be any television, computer monitor, or some other similar display device.

Game system 102 contains video game logic system (not shown) and statistical database 118. The video game logic system processes the data in the statistical database and controls the game play and all other necessary functions. Statistical database 118 contains fixed database 112 and variable database 114. Fixed database contains static data such as rules of the game, information to render playing environments, identifiable logic, and other aspects of the gaming environment that do not need to change.

In a sports based video game, variable database 114 contains data that must be updated in order to provide a realistic gaming environment. For example, variable database 114 contains information about what players are available to play the game, specific attributes about each player, such as the player's current season batting average or ERA, whether or not the player is injured and therefore cannot perform 100%, or what team the player plays for. Variable database 114 can be updated via flash RAM, ROM, CDROM, DVD, hard disk, through an Ethernet, LAN, WAN, the Internet, or other similar methods. The update link is preferably loaded into local RAM memory of the video game logic system that is processing and running the game. The updates may be free or charged on a onetime or subscription type basis.

In one embodiment, shown in FIG. 1, game system 102 is connected to network port 108 via cable 110. Network port 108 may be a connection to the Internet, an Ethernet, or some other network that allows access to data stored in a separate database. The separate database contains all the data necessary for game system 102 to mimic the real world dynamics of a particular sport.

Game system 102 retrieves data from the separate database via network port 108 and uses the data to update variable database 114. For example, if the present invention is used for a football game and in the current football season one player has a season ending injury, a second player, who plays quarterback, has a strained shoulder that prevents him from being accurate, a third player is traded to anther team, and a fourth player is an old veteran running back that has regained his old form and has exceeded everybody's expectations, then all the necessary information to update game system 102 would be contained in the separate database and downloaded to variable database 114 and variable database 114 would be updated accordingly.

The update may occur when game system 102 is activated and can connect to the separate database via network port 108, when an update button is pressed on game system 102, or on a periodical interval such as daily, weekly or monthly.

Using the above example of four players, after the update has occurred, when a game is played on game system 102, player one would not be available, player two would have a lower accuracy rating and would not complete many of his passes, player three would have a different uniform, and player four would be a stronger running back and gain more yards per carry. By updating variable database 114, the players would mimic the real sports world.

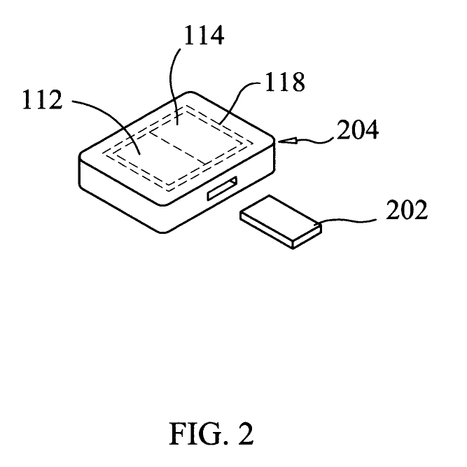

In another embodiment, shown in FIG. 2, game cartridge 204 contains the statistic database 118 which includes fixed database 112 and variable database 114. Flash media 202 is used to update variable database 114. In one embodiment, flash media 202 contains the entire variable database 114.

In another embodiment, flash media 202 contains only the portion of variable database 114 that needs to be updated. When flash media is inserted into game cartridge 204, the video game logic system extracts from flash media 202 all the necessary information to update the game system 102. In another embodiment, flash media 202 is inserted directly into game system 102 and the video game logic system uses the information on flash media 202 to update variable database 114 in game cartridge 204 to mimic the real sports world.

In yet another embodiment, the variable database 114 contains information about the environment or special rules or information about enemies, game maps, where to find specific items, money, weapons, or other items such as “Easter eggs” hidden within the game. The flash media or network port is used to unlock hidden features or invoke special rules such as unlimited life, weapons, money, power, or other attributes. Also the flash media or network port could be used to child proof a game and make the game more child friendly or to unlock any parental controls installed on the game. For example, in a first person shooter game the weapon could be a slingshot instead of a gun and the “victims” could be knocked out or otherwise wounded instead of killed.

It should be understood that the foregoing relates to exemplary embodiments of the invention and that modifications may be made without departing from the spirit and scope of the invention as set forth in the following claims.

What is claimed is:

1. A core video game application for providing a statistical updating mechanism, the game application comprising:
a video game logic and a statistical database;
a statistical database comprising a complete statistical data set necessary to operate the game application wherein the statistical database comprises a fixed portion containing fixed data and a variable portion containing variable data wherein the variable can be replaced with at least one updated statistical data set.

2. The game application in claim 1, wherein the video game logic system processes the data in the statistical database and controls the game play.

3. The game application in claim 2, wherein at least one data set in the variable portion is replaced with the at least one updated statistical data set via the Internet.

4. The system as in claim 2, wherein at least one data set in the variable portion is replaced with the at least one updated statistical data set via a WAN.

5. The system as in claim 2, wherein at least one data set in the variable portion is replaced with the at least one updated statistical data set via a LAN.

6. The system as in claim 2, wherein the at least one updated statistical data is provided on a non-volatile storage medium.

7. The system as in claim 7, wherein the non-volatile storage medium is, at least, one of; flash media, a CD (compact disk), a DVD, semiconductor memory, a hard disk.

8. The system as in claim 2 wherein the game application is for a sports video game.

9. The system as in claim 2 wherein the at least one statistic data set is replaced when the game application is activated.

10. The system as in claim 2 wherein the at least one statistic data set is replaced on a periodic interval.

11. A method for updating at least one data set in a core video game application, the method comprising the steps of:
accessing at least one updated data set;
updating a core video game application with the at least one updated data set wherein the video game application comprising:
a video game logic wherein the game logic processes the data in the statistical database and controls the game play and a statistical database;
a statistical database comprising a complete statistical data set necessary to operate the game application wherein the statistical database comprises a fixed portion containing fixed data and a variable portion containing variable data that can be replaced with the at least one updated statistical data set.

12. The method of claim 11, wherein the at least one data set is located on a remote server.

13. The method of claim 11, wherein the remote server is accessed via the Internet.

14. The method of claim 11, wherein the remote server is accessed via a WAN.

15. The method of claim 11, wherein the at least one data set is located on a non-volatile storage medium.

16. The method of claim 11, wherein the non-volatile storage medium is, at least, one of the following: flash media, a CD (compact disk), a DVD, semiconductor memory, a hard disk.

17. The method of claim 11 wherein the game application is for a sports video game.

18. The method of claim 11 wherein the at least one updated statistic data set is accessed when the game application is activated.

19. The method of claim 11 wherein the at least one updated statistic data set is accessed on a periodic interval.

20. A core video game application for providing a statistical updating mechanism, the game application comprising:
a video game logic wherein the video game logic system processes the data in the statistical database and controls the game play and a statistical database;
a statistical database comprising a complete statistical data set necessary to operate the game application wherein the statistical database comprises a fixed portion containing fixed data and a variable portion containing variable data that can be replaced with at least one different statistical data se via the Internet.
